(19) United States
(12) Patent Application Publication
(10) Pub. No.: US 2015/0138361 A1
(43) Pub. Date: May 21, 2015

(54) LANE DEPARTURE WARNING APPARATUS

(71) Applicant: DENSO CORPORATION, Kariya-city (JP)

(72) Inventor: Junpei Tatsukawa, Chiryu-shi (JP)

(21) Appl. No.: 14/541,339

(22) Filed: Nov. 14, 2014

(30) Foreign Application Priority Data
Nov. 15, 2013 (JP) 2013-236975

(51) Int. Cl. G06K 9/00; B60R 1/00

(52) U.S. Cl. CPC G06K 9/00798; B60R 1/00
USPC 348/148

(57) ABSTRACT

A lane departure warning apparatus is mounted to a vehicle, and issues a warning when there is a probability of departure of the vehicle from a traffic lane. The lane departure warning apparatus includes a lane recognizing unit, a departure determining unit, a warning unit, and a warning control unit. The lane recognizing unit recognizes the traffic lane on which the vehicle is traveling. The departure determining unit determines a probability of departure of the vehicle from the traffic lane based on a correlation between the vehicle and the traffic lane recognized by the lane recognizing unit. The warning unit issues a warning to a driver regarding the probability of departure. The warning control unit changes a level of warning issued by the warning unit based on the probability of departure.

### CROSS-REFERENCE TO RELATED APPLICATION

This application is based on and claims the benefit of priority from Japanese Patent Application No. 2013-236975, filed Nov. 15, 2013, the disclosure of which is incorporated herein in its entirety by reference.

### BACKGROUND

1. Technical Field

The present invention relates to a technology for warning a driver of the probability (likelihood) of departure (deviation) of a vehicle from a traffic lane.

2. Related Art

As a technology for issuing a warning regarding departure of a vehicle from a traffic lane, a following technology is conventionally known (JP-A-2010-058739). Whether or not the vehicle will deviate from the traffic lane is determined. When determined that the vehicle will deviate from the traffic lane, a warning sound is generated from a speaker or the steering wheel is vibrated.

For example, in the technology in JP-A-2010-058739, when the vehicle deviates from the traffic lane, a warning is issued to the driver by a warning sound being generated from a speaker. The speaker serves as a warning apparatus. In other words, in the technology in JP-A-2010-058739, the warning is issued to the driver by the warning apparatus being switched from an OFF state to an ON state.

As a result of the warning apparatus being switched from the OFF state to the ON state, the driver recognizes that the vehicle will deviate from the traffic lane. However, a problem occurs in that the driver cannot recognize the degree of probability of departure merely by the warning apparatus simply entering the ON state.

### SUMMARY

It is thus desired to solve at least some of the above-described problems. The present disclosure can be actualized by the following aspects.

An exemplary embodiment of the present disclosure provides a lane departure warning apparatus, mounted to a vehicle, for issuing a warning when there is a probability (equivalent to a risk) of departure of the vehicle from a traffic lane. The lane departure warning apparatus includes a lane recognizing unit, a departure determining unit, a warning unit, and a warning control unit.

The lane recognizing unit recognizes the traffic lane on which the vehicle is traveling. The departure determining unit determines the probability of departure of the vehicle from the traffic lane based on a correlation between the vehicle and the traffic lane recognized by the lane recognizing unit. The warning unit issues a warning to the driver regarding the probability of departure. The warning control unit changes the level of warning outputted by the warning unit based on the probability of departure.

In the lane departure warning apparatus, the level of warning changes based on the probability of departure. Therefore, the driver can know the degree of probability of departure based on the level of warning.

Not all of the plurality of elements included in each aspect of the above-described present disclosure are essential. Some constituent elements among the plurality of constituent elements may be modified, omitted, exchanged with other new constituent elements, or be modified to remove some limitations as appropriate to solve some or all of the above-described problems or to achieve some or all of the effects described in the present specification.

In addition, some or all of the technical features included in an aspect of the above-described present disclosure may be combined with some or all of the technical features included in another aspect of the above-described present disclosure, thereby forming a separate aspect of the present disclosure, to solve some or all of the above-described problems or to achieve some or all of the effects described in the present specification.

The present disclosure can be actualized by various aspects other than the lane departure warning apparatus. For example, the present disclosure can be actualized by aspects such as a method for controlling a lane departure warning apparatus, a program for enabling a lane departure warning apparatus to perform a control method, a lane departure warning system, or a vehicle including a lane departure warning apparatus or a lane departure warning system.

### BRIEF DESCRIPTION OF THE DRAWINGS

In the accompanying drawings:

FIG. 1 is a configuration diagram of a vehicle according to an embodiment;

FIG. 2 is a diagram of when a vehicle deviates from a traffic lane;

FIG. 3A is a diagram of a relationship between time and duty ratio in a first example;

FIG. 3B is a diagram of a relationship between the degree of probability of departure and duty ratio in the first example;

FIG. 4 is a diagram of an operation of a buzzer that is performed using the relationships shown in FIG. 3A and FIG. 3B;

FIG. 5 is a flowchart of a control process in the first example;

FIG. 6 is a diagram of a relationship between the degree of probability of departure and vibration frequency in a second example;

FIG. 7 is a flowchart of a control process in the second example;

FIG. 8 is a diagram of a relationship between the degree of probability of departure and index value in a third example;

FIG. 9 is a gradation value table defining a relationship between the index value and RGB gradation value;

FIG. 10 is a flowchart of a control process in a third example;

FIG. 11 is a diagram of a relationship between the degree of probability of departure and duty ratio in a fourth example;

FIG. 12 is a flowchart of a control process in the fourth example;

FIG. 13 is a diagram of a relationship between the degree of probability of departure and sound volume in a fifth example;

FIG. 14 is a flowchart of a control process in the fifth example;

FIG. 15 is a diagram of when a vehicle is traveling;

FIG. 16 is a diagram of a relationship between the degree of probability of departure and duty ratio in a sixth example; and

FIG. 17 is a flowchart of a control process in the sixth example.

### DESCRIPTION OF THE EMBODIMENTS

### A. Embodiments

### A-1. Configuration of a Vehicle

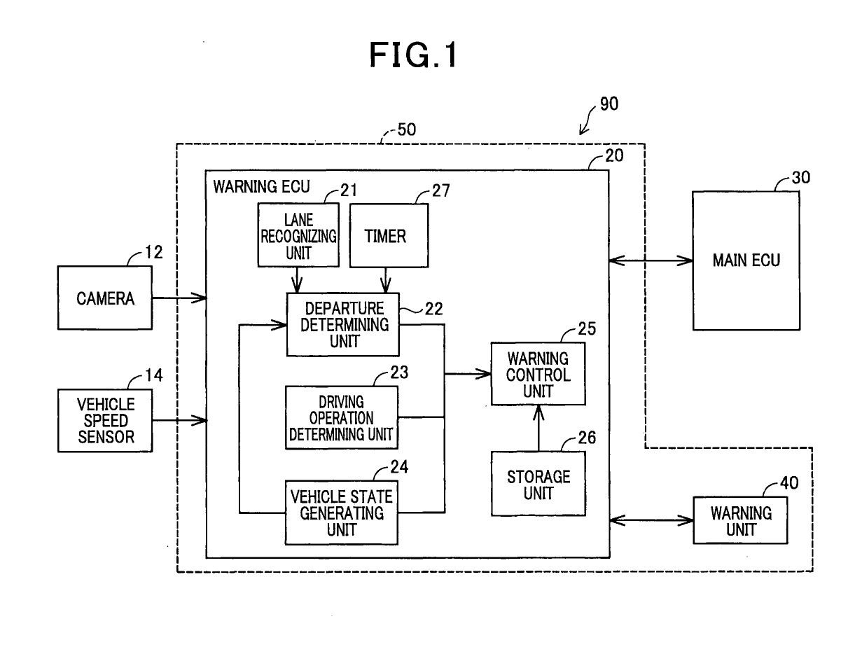

As shown in FIG. 1, a vehicle 90 according to an embodiment of the present invention includes a camera 12, a vehicle speed sensor 14, a lane departure warning apparatus 50, and a main electronic control unit (ECU; the same applies hereafter) 30. The lane departure warning apparatus 50 includes a warning unit 40 and a warning ECU 20. The warning ECU 20 controls the operation of the warning unit 40. The camera 12 captures images of the road surface ahead of the vehicle 90. The camera 12 transmits the captured image information to the warning ECU 20. The vehicle speed sensor 14 detects the vehicle speed V (m/s) of the vehicle 90. The vehicle speed sensor 14 transmits the detected speed information of the vehicle 90 to the warning ECU 20.

The main ECU 30 controls the driving operation of the vehicle 90. Specifically, the main ECU 30 controls the operations of each apparatus related to the driving operation of the vehicle 90. The apparatuses include an accelerator, a brake, a steering wheel, a turn signal, a display panel, and the like. The display panel displays various pieces of information, such as a speedometer and a tachometer. The speedometer displays the vehicle speed V. The tachometer displays the rotation speed of the engine. The background screen of the display panel is a liquid crystal panel.

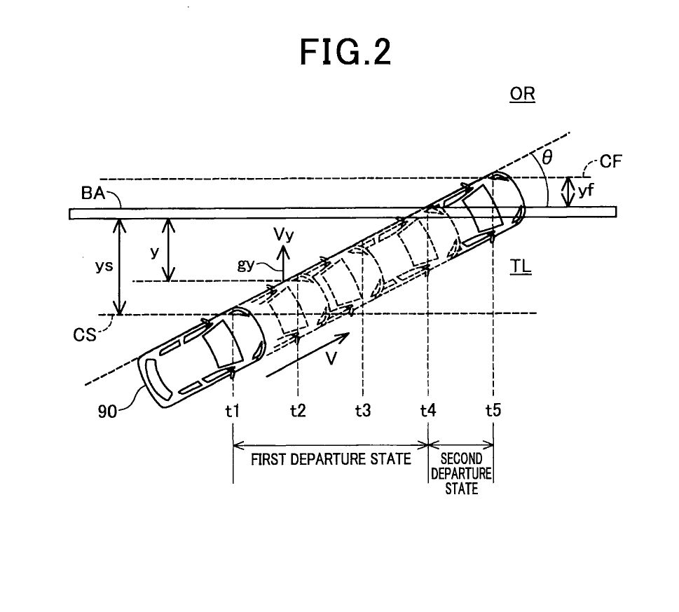

The lane departure warning apparatus 50 warns the driver of a probability (equivalent to a risk) of departure of the vehicle 90 from a traffic lane (TL) (FIG. 2). Specifically, the warning ECU 20 acquires information from the camera 12, the vehicle speed sensor 14, and the main ECU 30. The warning ECU 20 controls the operation of the warning unit 40 based on the acquired information, thereby issuing a warning to the driver.

Here, the probability of departure from the traffic lane TL includes a state in which it is likely that the vehicle 90 is currently deviating from the traffic lane TL. In addition, the probability of departure from the traffic lane TL also includes a state in which it is likely that the vehicle 90 will deviate from the traffic lane TL in the future.

A state in which there is a probability of departure is a state in which the vehicle 90 is present between a first specified position and a second specified position. The first specified position (control intervention position CS in FIG. 2) is a position at which a departure determining unit 22 (FIG. 2) decides to start the warning regarding the probability of departure. The second specified position (control end position CF in FIG. 2) is a position at which the departure determining unit 22 decides to end the warning. The departure determining unit 22 is provided in the warning ECU 20.

As shown in FIG. 2, according to the present embodiment, when the vehicle 90 is traveling on the traffic lane TL, the warning issued to the driver using the warning unit 40 is started once the vehicle 90 arrives at the control intervention position CS. The control intervention position CS is set to a position within the traffic lane TL that is a predetermined distance ys away from a boundary line BA of the traffic lane TL, in the width direction of the traffic lane TL (also referred to as simply “width direction”). The control intervention position CS is preferably set to a position that is determined unlikely for the vehicle 90 to travel during ordinary straight-ahead cruising.

The predetermined distance ys that prescribes the control intervention position CS may be set to a fixed value (such as 1 m) that has been determined in advance. Alternatively, the predetermined distance ys may be changed depending on the driving state of the vehicle 90 (such as lateral direction speed Vy and angle of entry θ of the vehicle 90, described hereafter). In addition, according to the present embodiment, the reference used to determine whether or not the vehicle 90 has arrived at the control intervention position CS is set to the following sections of the vehicle 90.

(i) When the boundary line BA is positioned on the left side in the advancing direction (traveling direction) of the vehicle 90, the front left tire of the vehicle 90 serves as the reference (FIG. 2).

(ii) When the boundary line BA is positioned on the right side in the advancing direction of the vehicle 90, the front right tire of the vehicle 90 serves as the reference.

In FIG. 2, the advancement of the vehicle 90 is shown in sequence at times t1, t2, t3, t4, and t5. The vehicle 90 is traveling at the vehicle speed V at the angle of entry θ. The angle of entry θ is an angle formed by the advancing direction of the vehicle 90 and the boundary line BA. According to the present embodiment, the vehicle 90 (specifically, the front left tire) arrives at the control intervention position CS at time t1. The vehicle 90 arrives at the boundary line BA at time t4. In addition, the vehicle 90 arrives at the control end position CF at time t5.

The control end position CF is set to a position in an area OR (area OR on the outer side of the traffic lane TL) that is a predetermined distance yf away from the boundary line BA in the width direction. The area OR is on the side opposite to the traffic lane TL on which the vehicle 90 is traveling with the boundary line BA therebetween. The control end position CF is preferably set to a position where determination can be made that the driver has intentionally crossed the boundary line BA to change traffic lanes or the like. The control end position CF is set to a position in which, for example, the predetermined distance yf is a length that is half the width of the vehicle 90.

As shown in FIG. 1, the warning ECU 20 includes a lane recognizing unit 21, the departure determining unit 22, a driving operation determining unit 23, a vehicle state generating unit 24, a warning control unit 25, a storage unit 26, and a timer 27. The lane recognizing unit 21 recognizes the traffic lane TL (FIG. 2) on which the vehicle 90 is traveling, based on image information from the camera 12. The traffic lane TL also includes the boundary line BA of the traffic lane TL.

The departure determining unit 22 determines whether or not there is a probability of departure of the vehicle 90 from the traffic lane TL. Specifically, as shown in FIG. 2, the departure determining unit 22 calculates the angle of entry θ and a lateral direction distance y, based on information acquired from the camera 12. The lateral direction distance y is the distance between the boundary line BA and the vehicle 90 in the width direction.

The departure determining unit 22 then determines whether or not a predetermined departure condition is met based on the angle of entry θ and the lateral direction distance y. When determined that the predetermined departure condition is met, the departure determining unit 22 determines that there is a probability of departure of the vehicle 90 from the traffic lane TL. The predetermined departure condition is that the vehicle 90 is advancing in a direction deviating from the traffic lane TL and the vehicle 90 has arrived at the control intervention position CS.

In addition, the departure determining unit 22 determines a control end timing regarding the operation of the warning unit 40 using the warning control unit 25. A method for determining the control end timing will be described hereafter. In addition, the departure determining unit 22 also determines the degree of probability of departure of the vehicle 90 from the traffic lane TL based on the correlation between the vehicle 90 and the traffic lane TL recognized by the lane recognizing unit 21 (such as the distance between the boundary line BA and the vehicle 90 or the time required for the vehicle 90 to arrive at the boundary line BA).

The driving operation determining unit 23 determines whether or not the driving operation by the driver has changed, based on information acquired from the main ECU 30.

The vehicle state generating unit 24 generates reference information based on information acquired from external devices, such as the camera 12 and the vehicle speed sensor 14. The reference information is used by determine the level of the warning outputted by the warning unit 40.

For example, as shown in FIG. 2, the reference information includes at least one type of information among the angle of entry θ, the lateral direction distance y, the vehicle speed V, and lateral acceleration gy. The lateral acceleration gy is the acceleration of the vehicle 90 in the lane width direction. The angle of entry θ and the lateral direction distance y are generated based on information acquired from the camera 12. The lateral acceleration gy is generated based on changes in the vehicle speed V acquired from the vehicle speed sensor 14. In the present specification, the modifier “lateral” in “lateral direction” and “lateral acceleration” is used to modify matters related to the width direction of the traffic lane TL (lane width direction).

The warning control unit 25 determines the level of warning to be outputted by the warning unit 40 based on the probability of departure determined by the departure determining unit 22. The storage unit 26 stores therein a program or the like used by the warning control unit 25 to determine the level of warning. The warning control unit 25 controls the operation of the warning unit 40 based on the determined level of warning.

The timer 27 provides a function for detecting the current time. In addition, the timer 27 provides a function for detecting and storing the time at which each operation is performed, for each operation performed by the warning ECU 20.

The warning unit 40 issues a warning to the driver based on the degree of probability of departure of the vehicle 90 from the traffic lane TL. The warning unit 40 includes at least one among a buzzer, the display panel and the steering wheel. The output from the warning unit 40 includes at least one type among a buzzer sound (such as sounding duration or sound frequency), display panel color, and vibration frequency of the steering wheel.

### A-2. First Example of Control

A first example of control performed by the lane departure warning apparatus 50 will be described with reference to FIG. 2 to FIG. 5. In the first example, a buzzer 40 is used as the warning unit 40. The level of warning is expressed by the sounding duration (duty ratio) of the buzzer 40. The degree of probability of departure is expressed by a predicted amount of time (predicted arrival time) required for the vehicle 90 to arrive at the boundary line BA. The boundary line BA serves as a warning reference position.

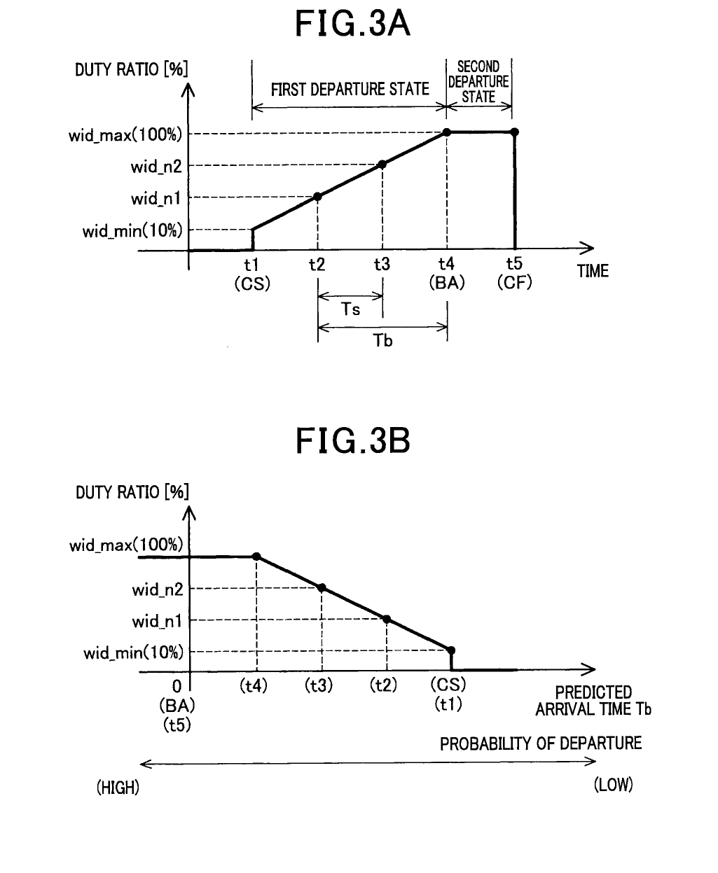

The horizontal axis in FIG. 3A indicates time. The vertical axis indicates the proportion of ON time (duty ratio) of the buzzer 40. FIG. 3B is a diagram of the relationship between the degree of probability of departure and the duty ratio in FIG. 3A. The horizontal axis in FIG. 3B indicates the probability of departure. The vertical axis indicates the proportion of ON time (duty ratio) of the buzzer 40. The warning reference position is used as reference to determine the level of warning. According to the present embodiment, the warning reference position is a position at which the duty ratio (level of warning) is maximum (100%).

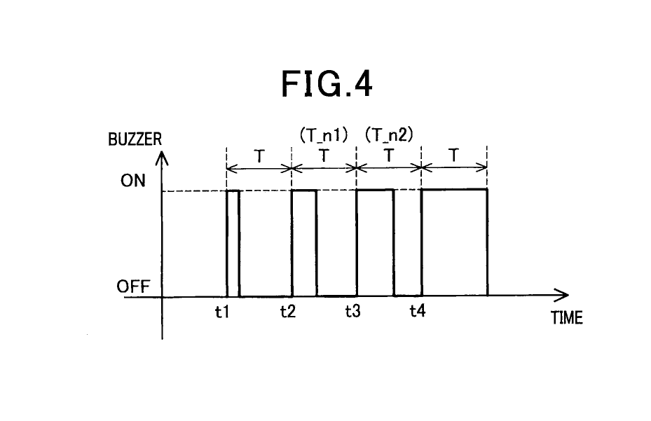

The departure determining unit 22 determines that the probability of departure is higher as the predicted arrival time Tb becomes shorter. The level of warning increases as the duty ratio of the sounding increases. In other words, the level of warning increases as the sounding duration increases. As shown in FIG. 4, the warning control unit 25 controls the sounding duration of the buzzer 40 by pulse width modulation (PWM) control. The PWM cycle T is set to a fixed cycle.

The warning control unit 25 controls the operation of the buzzer 40 so that the duty ratio increases as the vehicle 90 nears the boundary line BA from the control intervention position CS (as the predicted arrival time Tb decreases). For example, the warning control unit 25 controls the operation of the buzzer 40 so that the duty ratio is greater when the predicted arrival time Tb is short at time t3, compared to when the predicted arrival time Tb is long at time t2.

As a result, the driver can be notified of the changes in the probability of departure by the changes in the sounding duration of the buzzer 40. In addition, the range of the duty ratio controlled by the warning control unit 25 is set as follows. That is, the duty ratio is set to a minimum value wid_min at the control intervention position CS. The duty ratio is set to a maximum value wid_max at the boundary line BA. For example, the minimum value wid_min is set to 10%. The maximum value wid_max is set to 100%.

Here, the following expression is established regarding the movement of the vehicle 90 that is advancing as shown in FIG. 2.

0=y+Vy×Tb+1/2×gy×Tb² (1)

Here, y denotes the lateral direction distance (m). Vy denotes the lateral direction speed (m/s) of the vehicle 90. Tb denotes the predicted arrival time (sec) of the vehicle 90. The predicted arrival time refers to the amount of time required for the vehicle 90 to arrive at the boundary line BA from the starting point of the current cycle.

In addition, gy denotes the lateral acceleration (m/s²) of the vehicle 90. The lateral direction speed Vy and the lateral acceleration gy become negative in the direction towards the boundary line BA from the control intervention position CS in the lane width direction. The lateral direction speed Vy is calculated using the vehicle speed V and the angle of entry θ. The lateral acceleration gy is calculated using the acceleration of the vehicle 90 in the advancing direction and the angle of entry θ.

The warning control unit 25 determines the sounding duration of the buzzer 40 indicating the graphs in FIG. 3A and FIG. 3B, using the following expressions.

(i) When the vehicle 90 is positioned between the control intervention position CS and the boundary line BA (first departure state in FIG. 2):

$$wid\_n2 = ( \frac{100 - wid\_n1}{Tb} ) Ts + wid\_n1 \qquad ( 2 )$$

Here, wid_n2 denotes the duty ratio (%) of the next cycle. In addition, wid_n1 denotes the duty ratio (%) of the current cycle. Ts denotes elapsed cycle time (sec). The elapsed cycle time refers to the amount of time from the starting point of the cycle currently being run by the vehicle 90 to the current point. The elapsed cycle time Ts is calculated by the departure determining unit 22 based on information acquired from the timer 27. In addition, the departure determining unit 22 calculates the predicted arrival time Tb using expression (1).

The warning control unit 25 determines the sounding duration using above-described expression (2) in the first departure state. As a result, the duty ratio of the sounding can be increased as the predicted arrival time Tb decreases. In other words, the warning control unit 25 can set the level of warning to be higher as the probability of departure of the vehicle 90 from the traffic lane TL increases.

(ii) When the vehicle 90 is positioned between the boundary line BA and the control end position CF (second departure state in FIG. 2):

wid_{—}n2=wid_max (3)

After the vehicle 90 has arrived at the boundary line BA, the warning control unit 25 sets the duty ratio of the sounding to maximum using above-described expression (3). As a result, the driver can be made to notice the warning by the buzzer 40 with further certainty, when the probability of departure is the highest.

As described above, the warning control unit 25 changes the method for determining the sounding duration based on the state of departure of the vehicle 90 from the traffic lane TL (first and second departure states). The first and second departure states are determined by the departure determining unit 22 based on information from the camera 12.

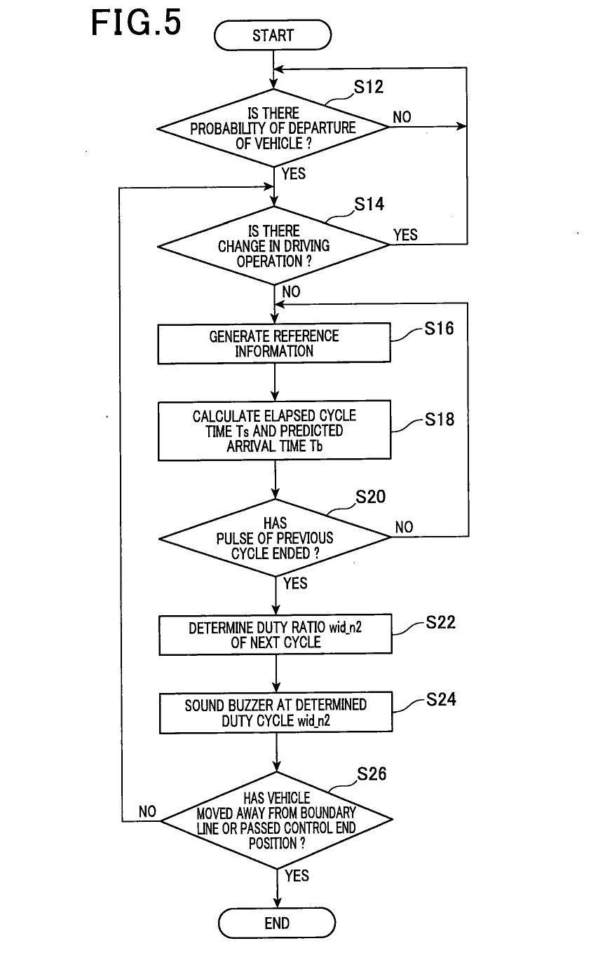

A control process of the first example performed by the lane departure warning apparatus 50 will be described with reference to FIG. 5.

The lane departure warning apparatus 50 repeatedly performs the control process shown in FIG. 5 at a predetermined time interval while the ignition switch of the vehicle 90 is turned ON.

First, the departure determining unit 22 determines whether or not there is a probability of departure of the vehicle 90 from the traffic lane TL (step S12). The departure determining unit 22 calculates the advancing direction and the lateral direction distance y from the boundary line BA based on information acquired from the camera 12.

When determined that the advancing direction of the vehicle 90 is a direction deviating from the traffic lane TL (a direction towards the boundary line BA) and the vehicle has arrived at the control intervention position CS, the departure determining unit 22 determines that there is a probability of departure of the vehicle 90 from the traffic lane TL.

When determined Yes at step S12, the driving operation determining unit 23 determines whether or not there is a change in driving operation, based on information acquired from the main ECU 30 (step S14). In the first example, there are four types of driving operations: accelerator operation, brake operation, turn signal operation, and steering operation (steering wheel operation).

When there are no changes in any of the four types of operations, the driving operation determining unit 23 determines that there is no change in driving operation. On the other hand, when there is a change in at least one of the four types of driving operations, the driving operation determining unit 23 determines that there has been a change in driving operation.

Here, the driving operation determining unit 23 determines that there is no change in operation when there is no change whatsoever in the accelerator operation, the brake operation, and the steering operation. In addition, the driving operation determining unit 23 determines that there is no change in operation when the amount of change in the operation is less than a predetermined threshold. For example, when the steering torque in the steering operation is less than a first threshold, the driving operation determining unit 23 determines that there is no change in steering operation.

At step S14, all that is required is to determine whether or not the driver is paying attention to driving. The driving operations are not limited to the four types of operations, described above. For example, only some of the four types of operations may be used in the determination at step S14. In addition, the driving operation determining unit 23 may determine whether or not there is change in another operation (such as a gear shifting operation).

When determined No at step S14, the vehicle state generating unit 24 acquires information generated by the camera 12 and the vehicle speed sensor 14. The vehicle state generating unit 24 generates reference information based on the acquired information (step S16). The generated reference information includes the angle of entry 9, the lateral direction distance y, the vehicle speed V, and the lateral acceleration gy.

Next, the vehicle state generating unit 24 calculates the elapsed cycle time Ts based on information detected by the timer 27. In addition, the vehicle state generating unit 24 calculates the predicted arrival time Tb by applying the reference information to expression (1) stored in the storage unit 26 (step S18). On the other hand, when determined No at step S12 or when determined Yes at step S14, the lane departure warning apparatus 50 repeatedly performs step 12.

After step 18, the warning control unit 25 determines whether or not the ON pulse of the previous cycle (cycle currently being performed) has ended (step S20). Specifically, at step S20, the warning control unit 25 determines whether or not the ON period (high period) of the previous cycle has ended. The determination method at step S20 will be described hereafter in an example in which the current cycle is cycle T_n1 and the next cycle is cycle T_n2 in FIG. 4.

The warning control unit 25 determines whether or not the current time is after the time at which the ON period of the buzzer 40 in the cycle T_n1 ends (end time). When determined that the current time is after the end time, the warning control unit 25 determines that the pulse of the previous cycle has ended (Yes at step S20). On the other hand, when determined that the current time is before the end time, the warning control unit 25 determines that the pulse of the previous cycle T_n1 has not ended (No at step S20).

When determined Yes at step S20, the warning control unit 25 uses expression (2) or expression (3) stored in the storage unit 26 and determines the duty ratio wid_n2 of the next cycle (step S22). The warning control unit 25 sounds the buzzer 40 at the determined duty ratio wid_n2 (step S24). On the other hand, when determined No at step S20, the lane departure warning apparatus 50 performs process at step S16 again.

After step S24, the departure determining unit 22 determines whether or not to end the warning using the buzzer 40 (step S26). Specifically, the departure determining unit 22 determines whether or not either of a first end condition Cfa and a second end condition Cfb is met based on information acquired from the camera 12.

(1) First end condition Cfa: the vehicle 90 is advancing in a direction returning to the inside of the traffic lane TL from the boundary line BA.

(ii) Second end condition Cfb: the vehicle 90 has passed the control end position CF.

When determined by the departure determining unit 22 that either of the first end condition Cfa and the second end condition Cfb is met (Yes at step S26), the warning control unit 25 ends the warning using the buzzer 40. On the other hand, when determined that neither of the first end condition Cfa and the second end condition Cfb is met (No at step S26), the lane departure warning apparatus 50 performs the processes subsequent to step S14 again.

As described above, in the first example, the lane departure warning apparatus 50 changes the sounding duration of the buzzer 40 based on the predicted arrival time Tb. The predicted arrival time Tb indicates the degree of the probability of departure. The sounding duration of the buzzer 40 indicates the level of warning. Therefore, compared to when the sounding duration of the buzzer 40 is fixed, the probability of the driver noticing the warning by the buzzer 40 increases.

In addition, the lane departure warning apparatus 50 controls operation of the buzzer 40 so that the sounding duration of the buzzer 40 increases as the predicted arrival time Tb decreases. Therefore, the sounding duration increases as the probability of departure increases. As a result, the probability of the driver noticing the warning by the buzzer 40 is further increased.

In addition, the sounding duration of the buzzer 40 increases as the predicted arrival time Tb decreases. Therefore, the driver can know the degree of probability of departure based on the length of the sounding duration.

In addition, when the vehicle 90 is positioned on the boundary line BA, the lane departure warning apparatus 50 controls the sounding duration of the buzzer 40 to maximum (duty ratio: 100%). As a result, the driver can be made to notice the warning by the buzzer 40 with further certainty, in a state in which the vehicle 90 is positioned on the boundary line BA.

In addition, when either of the first end condition Cfa and the second end condition Cfb is met, the warning control unit 25 ends the warning using the buzzer 40 (Yes at step S26). As a result, a situation in which the warning using the buzzer 40 is excessively issued to the driver can be suppressed.

In addition, in the above-described first example, the lateral direction distance y (FIG. 2) may be used instead of the predicted arrival time Tb as a departure indicator indicating the degree of the probability of departure. In this instance, the departure determining unit 22 determines the probability of departure to be higher as the lateral direction distance y becomes shorter.

In addition, in the first departure state (FIG. 3A), the warning control unit 25 controls the operation of the buzzer 40 so that the duty ratio becomes greater as the lateral direction distance Y becomes shorter. Furthermore, in a manner similar to that in the first example, when the lateral direction distance y becomes zero, the duty ratio is set to the maximum value wid_max.

In addition, in a manner similar to that in the first example, in the second departure state (FIG. 3A), the duty ratio is set to the maximum value wid_max regardless of the lateral direction distance y. Furthermore, when the lateral direction distance y is used as the departure indicator, the relationship between the lateral direction distance y and the duty ratio may be changed based on the vehicle speed V.

In other words, when the lateral direction distance y is the same, the warning control unit 25 may control the operation of the buzzer 40 so that the duty ratio becomes greater as the vehicle speed V increases. The lateral direction distance y may also be used as the departure indicator instead of the predicted arrival time Tb in second and third examples, described hereafter.

### A-3. Second Example of Control

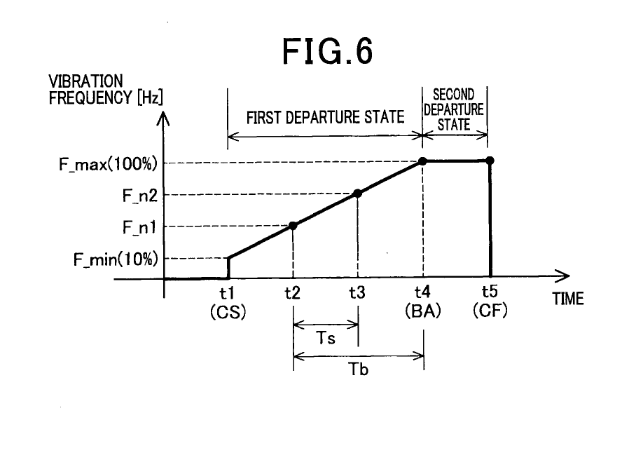

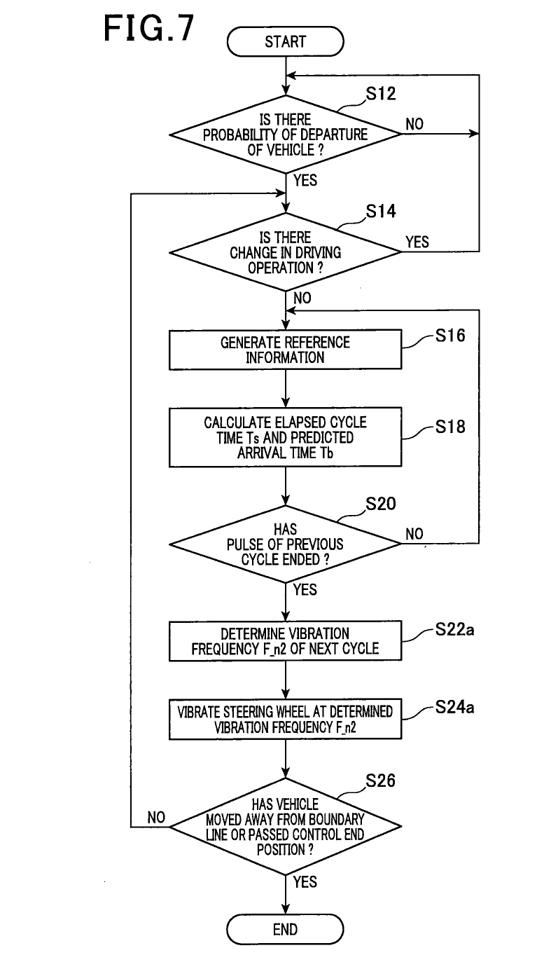

A second example of control performed by the lane departure warning apparatus 50 will be described with reference to FIG. 6 and FIG. 7. The second example differs from the first example in that a steering wheel 40 is used as the warning unit 40. The level of warning is expressed by the vibration frequency of the steering wheel 40 (specifically, a steering wheel actuator that applies vibrations to the steering wheel 40). The warning control unit 25 changes only the vibration frequency of the steering wheel 40. The proportion of the vibration duration in relation to a fixed cycle T (duty ratio) is held constant (such as to a duty ratio of 60%) and is not changed. The level of warning increases as the vibration frequency of the steering wheel 40 increases.

The horizontal axis in FIG. 6 is the same as the horizontal axis in FIG. 3A. The vertical axis indicates the vibration frequency of the steering wheel 40. In the second example, the warning control unit 25 controls the operation of the steering wheel 40 so that the vibration frequency increases as the vehicle 90 nears the boundary line BA from the control intervention position CS (as the predicted arrival time Tb decreases).

The range of the vibration frequency controlled by the warning control unit 25 is set as follows. The vibration frequency of the steering wheel 40 is set to a minimum value F_min at the control intervention position CS. The vibration frequency is set to a maximum value F_max at the boundary line BA. The minimum value F_min and the maximum value F_max are preferably set to a range that allows the driver to notice the warning by the driver being stimulated by the vibration of the steering wheel. For example, the minimum value F_min is set to 50 Hz. The maximum value F_max is set to 300 Hz. The warning control unit 25 determines the vibration frequency of the steering wheel 40 using the following expression. The expression indicates the graph in FIG. 6.

(i) In the first departure state in FIG. 2:

$$F\_n2 = ( \frac{F\_max - F\_n1}{Tb} ) Ts + F\_n1 \qquad ( 4 )$$

Here, F_n2 denotes the vibration frequency (Hz) of the next cycle. F_n1 denotes the vibration frequency of the current cycle.

The warning control unit 25 determines the vibration frequency using above-described expression (4) in the first departure state. As a result, the vibration frequency can be made higher as the predicted arrival time Tb becomes shorter.

(ii) In the second departure state in FIG. 2:

F_{—}n2=F_max (5)

After the vehicle 90 has arrived at the boundary line BA, the warning control unit 25 sets the vibration frequency to maximum using above-described expression (5). As a result, the driver can be made to notice the warning by the steering wheel 40 with further certainty, when the probability of departure is the highest.

The control process of the second example performed by the lane departure warning apparatus 50 will be described with reference to FIG. 7. The control process of the second example differs from the control process of the first example (FIG. 5) regarding step S22a and step S24a. Other steps are the same as those in the first example. Therefore, the same steps are given the same reference number and descriptions thereof are omitted.

When determined Yes at step S20, the warning control unit 25 determines the vibration frequency F_n2 of the next cycle using expression (4) or expression (5) stored in the storage unit 26 (step S22a). The warning control unit 25 then vibrates the steering wheel 40 at the determined vibration frequency F_n2 (step S24a). As a result of the steering wheel being vibrated, the driver can be warned of the probability of departure of the vehicle 90 from the traffic lane TL.

As described above, in the second example, the following effects are achieved in addition to the effects of the first example. In other words, the vibration frequency of the steering wheel is changed based on the degree of probability of departure. Therefore, the probability of the driver noticing the warning can be improved through the tactile sense of the driver. In addition, the vibration frequency increases as the probability of departure increases. Therefore, the driver can know the degree of probability of departure based on the magnitude of the vibration frequency.

### A-4. Third Example of Control

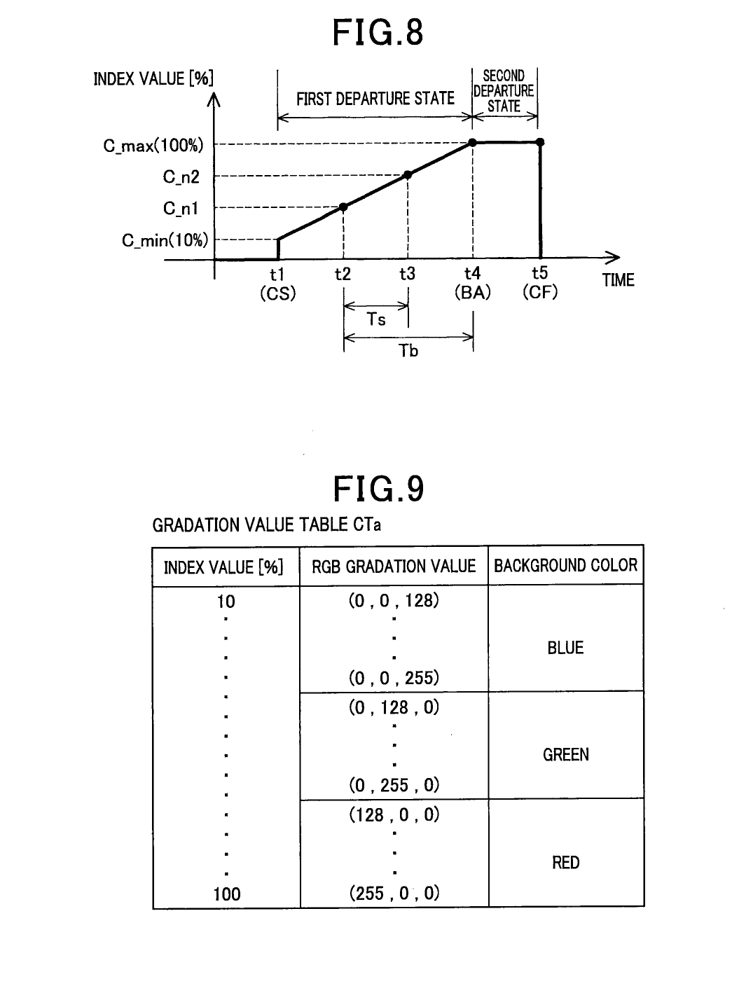

A third example of control performed by the lane departure warning apparatus 50 will be described with reference to FIG. 8 to FIG. 10. The third example differs from the first example in that a display panel 40 is used as the warning unit 40. The level of warning is expressed by the background color of the display panel 40 (the gradation value of each red, green, and blue (RGB) color component).

The warning control unit 25 changes only the color of the background screen (background color) of the speedometer and the tachometer on the display panel 40. The proportion of the display duration of the background color in relation to a fixed cycle T (duty ratio) is held constant (such as at a duty ratio of 80%) and is not changed.

The level of warning increases as the wavelength of the light of the background color increases (in other words, as the color becomes closer to red). In addition, the level of warning increases as the gradation value of the background color increases (in other words, as the brightness increases).

The warning control unit 25 controls the operation of the display panel 40 so that the background color changes in sequence to three stages of color: blue, green, and red, and the gradation value of each color increases, as the vehicle 90 nears the boundary line BA from the control intervention position CS (as the predicted arrival time Tb decreases).

The horizontal axis in FIG. 8 is the same as the horizontal axis in FIG. 3A. The vertical axis indicates an index value (%) for determining the gradation value of each RGB color (RGB gradation value). As shown in FIG. 9, the level of warning increases as the index value increases. As shown in FIG. 8, the index value is set to a minimum value C_min at the control intervention position CS. The index value is set to a maximum value C_max at the boundary line BA. For example, the minimum value C_min is set to 10%. The maximum value C_max is set to 100%.

In addition, as shown in FIG. 9, a gradation value table CTa is stored in the storage unit 26. In the gradation value table, gradation values that are respectively associated with index values are uniquely set. In actuality, the data shown in the index value column and the data shown in the gradation value column of the gradation value table are stored in the storage unit 26. The colors displayed on the background screen of the display panel 40 are shown in the right column of the gradation table Cta to facilitate understanding.

The warning control unit 25 determines the index value using the following expression. In addition, the warning control unit 25 determines the RGB gradation value associated with the index value by referencing the gradation value table CTa.

(i) In the first departure state in FIG. 2:

$$C\_n2 = ( \frac{100 - C\_n1}{Tb} ) Ts + C\_n1 \qquad ( 6 )$$

Here, C_n2 denotes the index value (%) of the next cycle. C_n1 denotes the index value (%) of the current cycle.

The warning control unit 25 determines the index value using above-described expression (6) in the first departure state. As a result, the index value can be made greater as the predicted arrival time Tb becomes shorter.

(ii) In the second departure state in FIG. 2:

C_{—}n2=C_max (7)

After the vehicle 90 has arrived at the boundary line BA, the warning control unit 25 sets the index value to maximum using above-described expression (7). As a result, the driver can be made to notice the warning by the background color with further certainty, when the probability of departure is the highest.

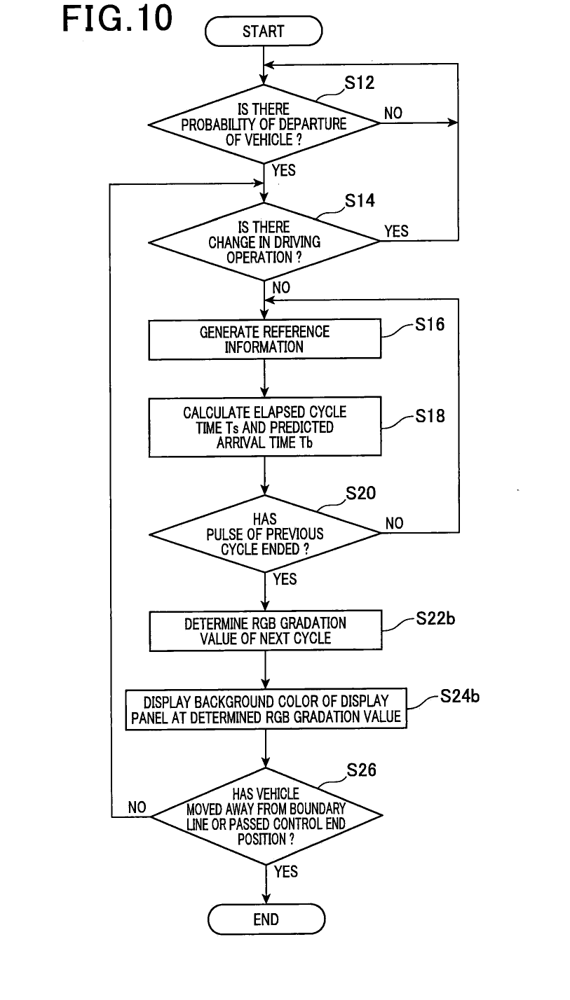

The control process of the third example performed by the lane departure warning apparatus 50 will be described with reference to FIG. 10. The control process of the third example differs from the control process of the first example (FIG. 5) regarding step S22b and step S24b. Other steps are the same as those in the first example. Therefore, the same steps are given the same reference number and descriptions thereof are omitted.

When determined Yes at step S20, the warning control unit 25 determines the RGB gradation value of the next cycle using expression (6) or expression (7) and the gradation value table Cta stored in the storage unit 26 (step S22b). The warning control unit 25 then displays the background color in the display panel 40 at the determined RGB gradation value of the next cycle (step S24b). As a result of the background color being displayed in the display panel 40, the driver can be warned of the probability of departure of the vehicle 90 from the traffic lane TL.

As described above, in the third example, the following effects are achieved in addition to the effects of the first example. In other words, the background color of the display panel 40 is changed based on the degree of probability of departure. Therefore, the probability of the driver noticing the warning can be improved through the vision of the driver. In addition, the wavelength of the light of the background color and the gradation value are increased as the probability of departure increases. Therefore, the driver can know the degree of probability of departure based on the changes in the wavelength of the light of the background color and the gradation value.

### A-5: Fourth Example of Control

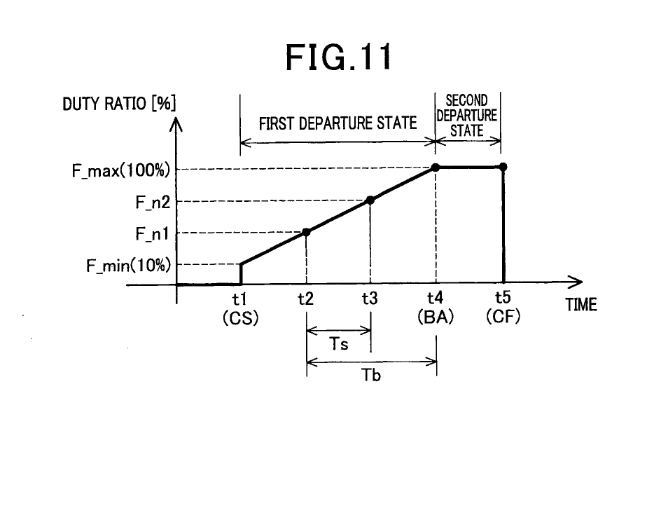

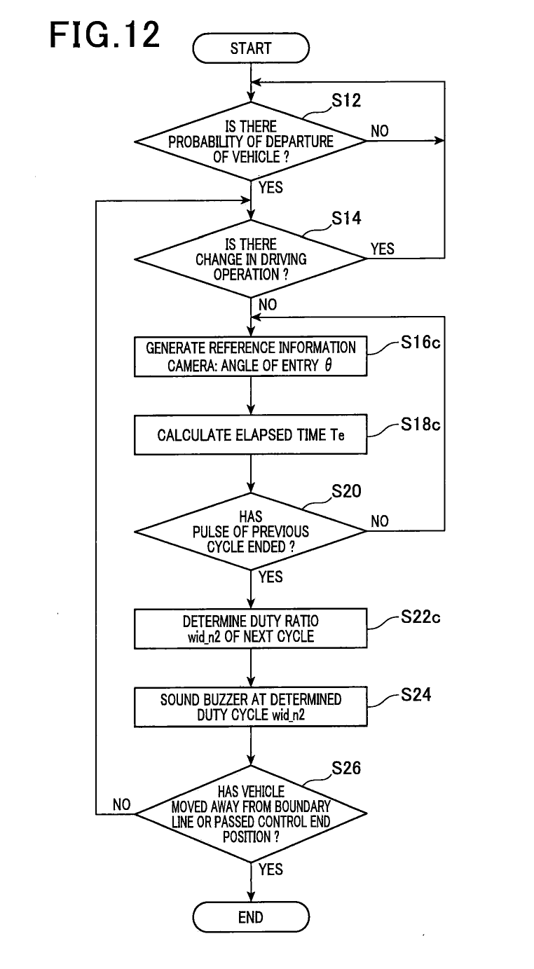

A fourth example of control performed by the lane departure warning apparatus 50 will be described with reference to FIG. 11 and FIG. 12. The fourth example differs from the first example in that the degree of probability of departure is expressed by elapsed time Te. The elapsed time Te indicates the amount of time elapsed from when the departure determining unit 22 determines that the vehicle 90 has arrived at the control intervention position CS. The probability of departure increases as the elapsed time Te increases.

The horizontal axis in FIG. 11 indicates time. The vertical axis indicates duty ratio. The warning control unit 25 determines the duty ratio wid_n2 of the next cycle using the following expression. The expression indicates the graph shown in FIG. 11.

(i) In the first departure state in FIG. 2:

wid_{—}n2=Tan θ×Te+wid_min (8)

The warning control unit 25 determines the sounding duration using above-described expression (8) in the first departure state. As a result, the duty ratio of the sounding can be increased as elapsed time Te increases. In other words, the warning control unit 25 can set the level of warning to be higher as the probability of departure of the vehicle 90 from the traffic lane TL increases.

(ii) In the second departure state in FIG. 2:

wid_{—}n2=wid_max (9)

After the vehicle 90 has arrived at the boundary line BA, the warning control unit 25 sets the duty ratio of the sounding to maximum using above-described expression (9). As a result, the driver can be made to notice the warning by the buzzer 40 with further certainty, when the probability of departure is the highest.

The control process of the fourth example performed by the lane departure warning apparatus 50 will be described with reference to FIG. 12. The control process of the fourth example differs from the control process of the first example (FIG. 5) regarding step s16c, step S18c, and step S22c. Other steps are the same as those in the first example. Therefore, the same steps are given the same reference number and descriptions thereof are omitted.

At step S16c, the vehicle state generating unit 24 acquires information generated by the camera 12 and generates reference information based on the acquired information (step S16c). The reference information indicates the angle of entry θ.

Next, the departure determining unit 22 calculates the elapsed time Te based on information detected by the timer 27 (step S18c). The lane departure warning apparatus 50 performs the process at step S20 after performing the process at step S18c. Then, when determined Yes at step S20, the warning control unit 25 determines the duty ratio wid_n2 of the next cycle using expression (8) or expression (9) stored in the storage unit 26 (step S22c).

The warning control unit 25 sounds the buzzer 40 at the determined duty ratio wid_n2 of the next cycle (step S24).

### A-6. Fifth Example of Control

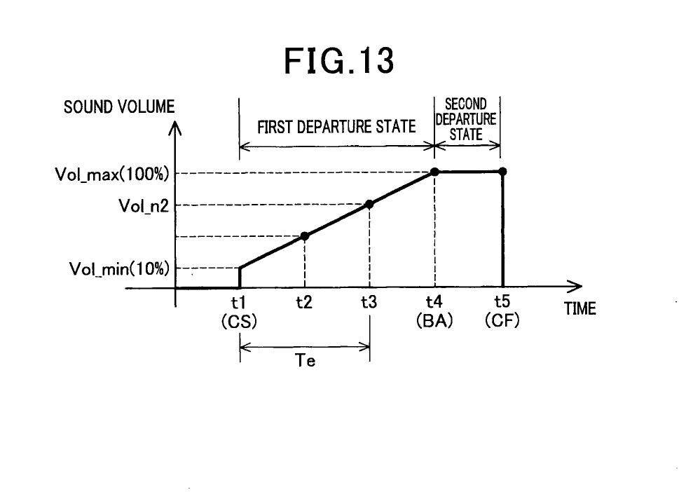

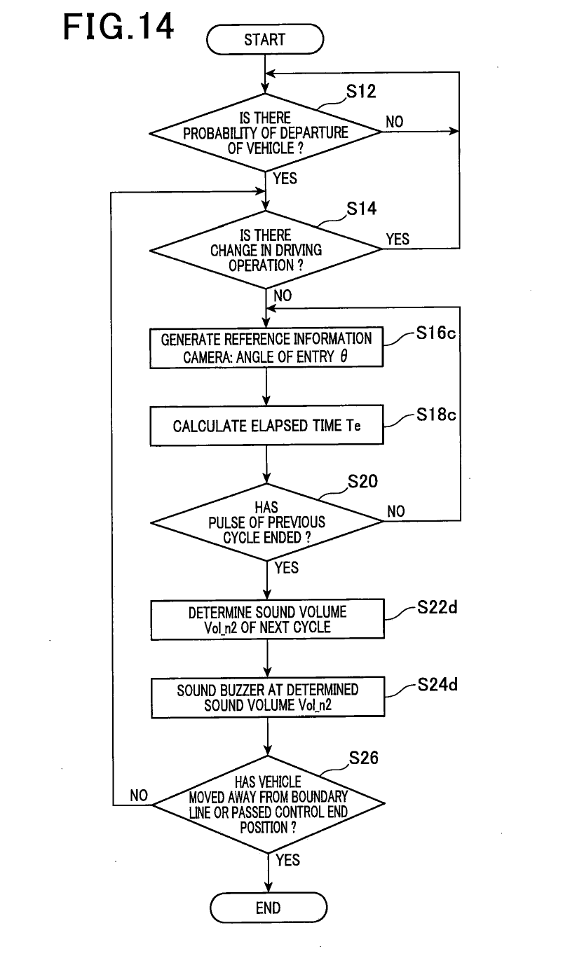

A fifth example of control performed by the lane departure warning apparatus 50 will be described with reference to FIG. 13 and FIG. 14. In the fifth example, the buzzer 40 is used as the warning unit 40. The level of warning is expressed by the sound volume of the buzzer 40. The fifth example differs from the fourth example in that the level of warning is expressed by the sound volume of the buzzer 40. The warning control unit 25 changes only the sound volume of the buzzer 40. The proportion of the sounding duration in relation to a fixed cycle T (duty ratio) is held constant (such as to a duty ratio of 60%) and is not changed. The level of warning increases as the sound volume increases.

The horizontal axis in FIG. 13 indicates time. The vertical axis indicates the proportion (%) of the sound volume. The range of the sound volume controlled by the warning control unit 25 is set as follows. The proportion of the sound volume is set to a minimum value Vol_min at time t1 when the vehicle is positioned at the control intervention position CS. The proportion of the sound volume is set to a maximum value Vol_max at time t4 when the vehicle 90 is positioned at the boundary line BA. In the fifth example, the minimum value Vol_min is set to 10% of the maximum value Vol_max.

The warning control unit 25 determines the sound volume of the buzzer 40 using the following expression. The expression indicates the graph in FIG. 13.

(i) In the first departure state in FIG. 2:

Vol_{—}n2=Tan θ×Te+Vol_min (10)

The warning control unit 25 determines the sound volume of the buzzer 40 using above-described expression (10) in the first departure state. As a result, the sound volume of the buzzer 40 can be increased as the elapsed time Te increases. In other words, the warning control unit 25 can set the level of warning to be higher as the probability of departure of the vehicle 90 from the traffic lane TL increases.

(ii) In the second departure state in FIG. 2:

Vol_{—}n2=Vol_max (11)

After the vehicle 90 has arrived at the boundary line BA, the warning control unit 25 sets the sound volume of the buzzer 40 to maximum using above-described expression (11). As a result, the driver can be made to notice the warning by the buzzer 40 with further certainty, when the probability of departure is the highest.

The control process of the fifth example performed by the lane departure warning apparatus 50 will be described with reference to FIG. 14. The control process of the fifth example differs from the control process of the fourth example (FIG. 12) regarding step S22d and step S24d. Other steps are the same as those in the fourth example. Therefore, the same steps are given the same reference number and descriptions thereof are omitted.

When determined Yes at step S20, the warning control unit 25 determines the sound volume Vol_n2 of the next cycle using expression (10) or expression (11) stored in the storage unit 26 (step S22d). The warning control unit 25 then sounds the buzzer 40 at the determined sound volume Vol_n2 (step S24d).

As described above, in the fourth and fifth examples, the following effects are achieved in addition to the effects of the first example. In other words, the degree of probability of departure is expressed by the elapsed time Te. The buzzer 40 is controlled so that the sounding duration of the buzzer 40 increases as the elapsed time Te decreases. As a result, the driver can know the degree of probability of departure based on the length of the sounding duration.

In addition, the warning control unit 25 can determine the duty ratio wid_n2 or the proportion of the sound volume Vol_n2 based on less information (angle of entry θ and elapsed time Te). In addition, the duty ratio or the proportion of the sound volume is changed based on the degree of probability of departure. Therefore, the probability of the driver noticing the warning by the buzzer 40 can be improved.

### A-7. Sixth Example of Control

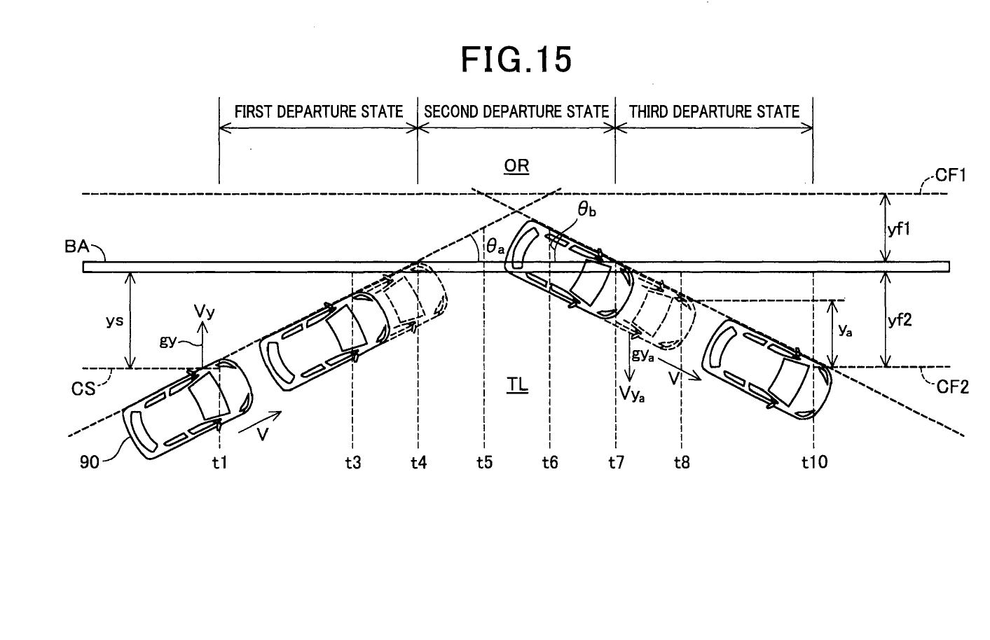

A sixth example of control performed by the lane departure warning apparatus 50 will be described with reference to FIG. 15 to FIG. 17. In the sixth example, the warning by the warning unit 40 is issued even when the vehicle 90 is traveling within the traffic lane TL in a direction away from the boundary line BA. In the sixth example, the buzzer 40 is used as the warning unit 40 in a manner similar to that in the first example. In addition, in the sixth example, the level of warning is expressed by the sounding duration (duty ratio) of the buzzer 40 in a manner similar to that in the first example.

The warning control unit 25 ends the warning using the warning unit 40 when either of the following first end condition Cf1 and second end condition Cf2 is met.

(i) First end condition Cf1: the vehicle has passed a first control end position Cf1 (FIG. 15).

(ii) Second end condition Cf2: the vehicle has passed a second control end position Cf2 (FIG. 15).

As shown in FIG. 15, the first control end position Cf1 is the same as the control end position CF (FIG. 2) in the first example. The first control end position Cf1 is set to a position within the area OR that is a predetermined distance yf1 away from the boundary line BA in the width direction.

The second control end position CF2 is set to a position where determination can be made that the driver has avoided departure from the traffic lane TL. In the sixth example, the second control end position CF2 is set to a position within the traffic lane TL that is a predetermined distance yf2 away from the boundary line BA in the width direction.

In the example shown in FIG. 15, the vehicle 90 arrives at the control intervention position CS at time t1. The vehicle arrives at the boundary line BA at time t4. In addition, the vehicle 90 changes the advancing direction between time t5 and time t6. The vehicle 90 arrives at the boundary line BA again at time t7. In addition, the vehicle 90 arrives at the second control end position CF2 at time t10. The vehicle 90 is positioned between the control intervention position CS and the boundary line BA at time t3. The vehicle 90 is positioned between the boundary line BA and the second control end position CF2 at time t8. As described above, in FIG. 15, after the vehicle 90 arrives at the control intervention position CS, the vehicle 90 changes the advancing direction to a direction returning inside the traffic lane TL. The vehicle 90 then arrives at the second control end position CF2. In addition, the vehicle 90 advances in the direction approaching the boundary line BA (direction deviating from the traffic lane TL) between time t1 and time t4. At this time, the vehicle 90 is traveling at the vehicle speed V at the angle of entry θₐ. The vehicle 90 then advances in the direction away from the boundary line BA (direction returning inside the traffic lane TL) between time t7 and time t10. At this time, the vehicle 90 is traveling at the vehicle speed V at the angle of entry θ_{b}.

Here, the following expression is established regarding the movement of the vehicle 90 that is advancing between time t7 and time t10 in FIG. 15.

0=yₐ+Vyₐ×Tc+1/2×gyₐ×Tc² (12)

Here, yₐ denotes the lateral direction distance (m) between the vehicle 90 and the second control end position CF2. Vyₐ denotes the lateral direction speed (m/s) of the vehicle 90. In addition, gyₐ denotes the lateral acceleration (m/s²) of the vehicle 90. The lateral direction speed Vyₐ and the lateral acceleration gyₐ become negative in the direction towards the second control end position CF2 from the boundary line BA in the lane width direction. In addition, Tc demotes the predicted arrival time (sec). The predicted arrival time refers to the amount of time required for the vehicle 90 to arrive at the second control end position CF2 from the current point.

The departure determining unit 22 calculates the predicted arrival time Tc by using expression (12). The predicted arrival time Tc expresses the degree of probability of departure.

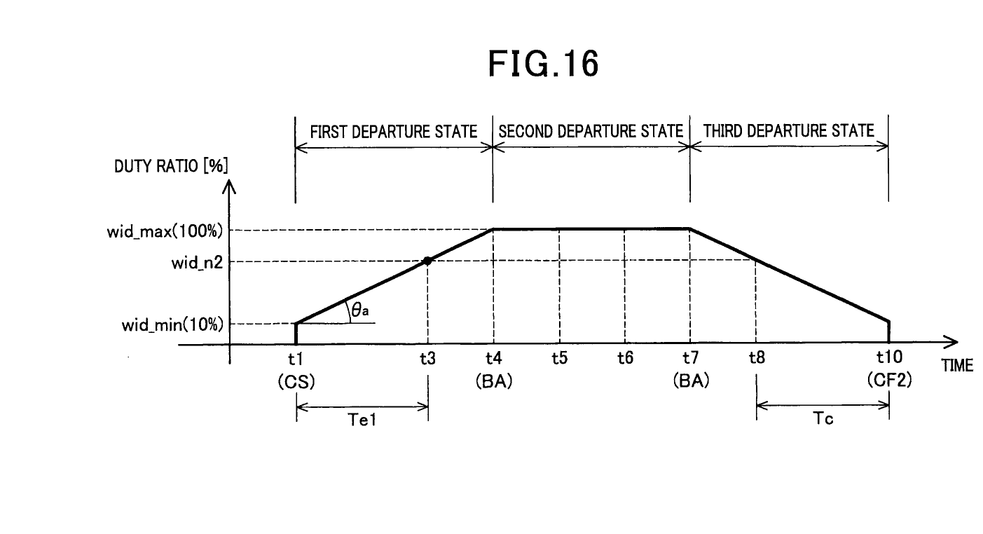

The warning control unit 25 determines the sounding duration (duty ratio) of the buzzer 40 using the following expression. The expression indicates in the graph in FIG. 16.

(i) When the vehicle 90 is advancing on the traffic lane TL in the direction approaching the boundary line BA and the vehicle 90 is positioned between the control intervention position CS and the boundary line BA (first departure state in FIG. 15)

wid_{—}n2=Tan θₐ×Te1+wid_min (13)

Here, Te1 denotes the elapsed time from when the vehicle 90 arrives at the control intervention position CS.

The warning control unit 25 determines the sounding duration using above-described expression (13) in the first departure state. As a result, the duty ratio of the sounding can be increased as the elapsed time te1 increases. In other words, the warning control unit 25 can set the level of warning to be higher as the probability of departure of the vehicle 90 from the traffic lane TL increases.

(ii) When the vehicle 90 is positioned between the boundary line BA and the first control end position CF1 (second departure state in FIG. 15)

wid_{—}n2=wid_max (14)

After the vehicle 90 has arrived at the boundary line BA, the warning control unit 25 sets the duty ratio of the sounding to maximum using above-described expression (14). As a result, the driver can be made to notice the warning by the buzzer 40 with further certainty, when the probability of departure is the highest.

(iii) When the vehicle 90 is advancing in the direction returning inside the traffic lane TL and the vehicle 90 is positioned between the boundary line BA and the second control end position CF2 (third departure state in FIG. 15)

wid_{—}n2=Tan θ_{b}×Tc+wid_min (15)

The warning control unit 25 determines the sounding duration using above-described expression (15) in the third departure state. As a result, the duty ratio of the sounding can be decreased as the predicted arrival time Tc decreases (as the vehicle 90 moves away from the boundary line BA). In other words, the warning control unit 25 can set the level of warning to be lower as the probability of departure of the vehicle 90 from the traffic lane TL decreases.

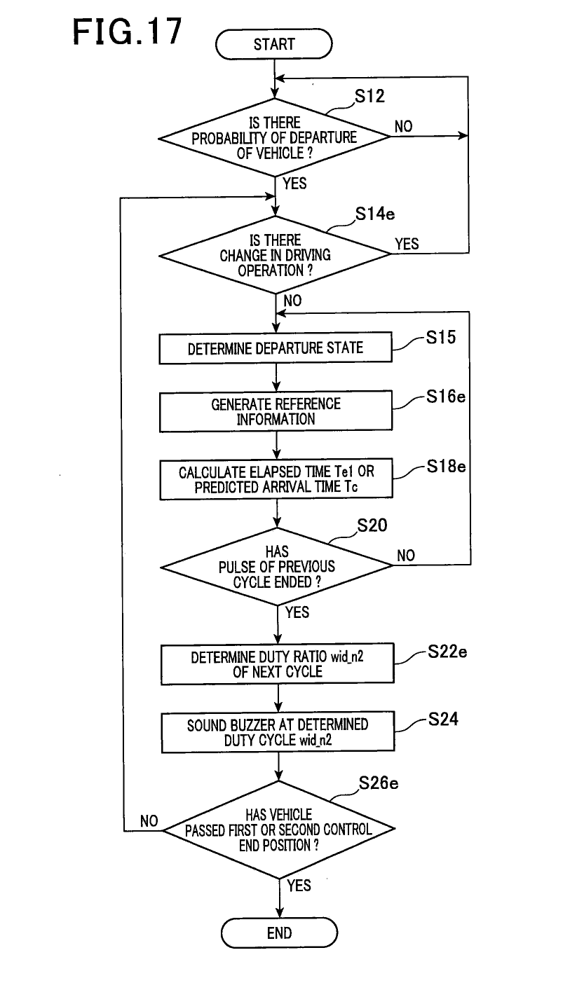

A control process of the sixth example performed by the lane departure warning apparatus 50 will be described with reference to FIG. 17. Steps that are the same as those in the control process of the first example are given the same reference numbers. Descriptions thereof are omitted. When determined Yes at sep S12, the driving operation determining unit 23 determines whether or not there is a change in driving operation, based on information acquired from the main ECU 30 (sep S14e). The driving operation in the sixth example is turn signal operation.

When determined No at step S14e, the departure determining unit 22 determines the departure state of the vehicle 90 based on information acquired from the camera 12 (step S15). The departure state is any of the first to third departure states (FIG. 16).

After the departure state is determined, the vehicle state generating unit 24 generates reference information (step S16e). The reference information is used to determine the duty ratio wid_n2 of the next cycle. The generated reference information is required for calculation of the duty ratio. For example, when the duty ratio wid_n2 is determined using expression (13), the reference information includes the angle of entry θₐ.

When the duty ratio is determined using expression (12) and expression (15), the reference information includes the angle of entry θb, the distance yₐ, the lateral direction speed Vyₐ, and the lateral acceleration gyₐ.

Next, the departure determining unit 22 calculates the elapsed time Te1 based on information detected by the timer 27. Alternatively, the departure determining unit 22 calculates the predicted arrival time Tc using expression (12) (step S18e). Specifically, when the warning control unit 25 determines the duty ratio using expression (13), the departure determining unit 22 calculates the elapsed time Te1.

When the warning control unit 25 determines the duty ratio using expression (15), the departure determining unit 22 calculates the predicted arrival time Tc. When the warning control unit 25 determines the duty ratio using expression (14), the duty ratio is a fixed value (maximum value wid_max). Therefore, the lane departure warning apparatus 50 performs the process at step S20 without performing the processes at step S16e and step S18e.

When determined Yes at step S20, the warning control unit 25 uses any of expression (13) to expression (15) stored in the storage unit 26 and determines the duty ratio wid_n2 of the next cycle (step S22). The warning control unit 25 uses any of expression (13) to expression (15) based on the departure state. The warning control unit 25 sounds the buzzer 40 at the determined duty ratio wid_n2 (step S24).

After step S24, the departure determining unit 22 determines whether or not to end the warning using the buzzer 40 (step S26e). Specifically, the departure determining unit 22 determines whether or not either of the first end condition Cf1 and the second end condition Cf2 is met based on information acquired from the camera 12.

When determined by the departure determining unit 22 that either of the first end condition Cf1 and the second end condition Cf2 is met (Yes at step S26e), the warning control unit 25 ends the warning using the buzzer 40. On the other hand, when determined that neither of the first end condition Cf1 and the second end condition Cf2 is met (No at step S26e), the lane departure warning apparatus 50 performs the processes subsequent to step S14 again.

As described above, in the sixth example, the following effects are achieved in addition to the effects in the first example. In other words, even when the vehicle 90 is advancing in the direction returning inside the traffic lane TL, the warning control unit 25 issues the warning using the buzzer 40. The warning using the buzzer 40 is issued until the vehicle 90 arrives at the second control end position Cf2.

As a result, even when the vehicle 90 is advancing in the direction returning inside the traffic lane TL, the warning using the buzzer 40 can be issued to the driver until the vehicle 90 moves the predetermined distance yf2 away from the boundary line BA in the width direction. Therefore, the probability of the driver mistakenly crossing the boundary line BA can be further reduced.

In addition, when the vehicle 90 is traveling on the traffic lane TL and the vehicle 90 is moving away from the boundary line BA (third departure state), the warning control unit 25 controls the operation of the buzzer 40 so that the duty ratio of the sounding decreases as the vehicle 90 moves farther from the boundary line BA. Therefore, the driver can know that the probability of departure has decreased by recognizing that the sounding duration has become shorter.

### B. Variation Examples

### B-1. First Variation Example

The lane departure warning apparatus 50 may control the operation of the warning unit 40 by combining at least two or more of the first to sixth examples. For example, the first and second examples may be combined. In this case, the lane departure warning apparatus 50 may use the buzzer 40 and the steering wheel 40 as the warning unit 40. The lane departure warning apparatus 50 may issue a warning to the driver by sounding the buzzer 40 and vibrating the steering wheel 40.

In addition, for example, the sixth example may be combined with the first to fifth examples. In other words, in the first to fifth examples, the warning using the warning unit 40 may be issued when the vehicle 90 is advancing in the direction returning inside the traffic lane TL.

### B-2. Second Variation Example

According to the above-described embodiment, when the buzzer 40 is used as the warning unit 40, the level of warning is expressed by the sounding duration (duty ratio) or the sound volume of the buzzer 40. However, this is not limited thereto. The level of warning is merely required to be expressed by the sounding state of the buzzer 40. The sounding state of the buzzer 40 includes the operation state, such as the sounding duration of the buzzer 40, the sound volume of the buzzer 40, the sound frequency of the buzzer 40, and the time interval of the OFF period of the buzzer 40.

For example, the warning control unit 25 may set the ON period of the buzzer 40 to a fixed period. The warning control unit 25 may perform control to change the OFF period. In this case, the warning control unit 25 may control the buzzer 40 so that the OFF period becomes shorter as the probability of departure increases.

In addition, when the level of warning is expressed by the sound frequency of the buzzer 40, the warning control unit 25 may control the operation of the buzzer 40 so that the frequency increases as the probability of departure increases. Even in such instances, the sounding state of the buzzer 40 changes based on the degree of probability of departure. Therefore, the driver can know the degree of probability of departure based on the changes in the sounding state of the buzzer 40. In addition, the probability of the driver noticing the warning using the buzzer 40 can be improved.

### B-3. Third Variation Example

According to the above-described embodiment, the warning control unit 25 controls the operation of the warning unit 40 so that the level of warning increases as the probability of departure increases. However, this is not limited thereto. The warning control unit 25 is merely required to control the operation of the warning unit 40 so that the level of warning changes depending on whether or not there is a probability of departure or the degree of probability of departure. For example, in the first example, the warning control unit 25 may control the operation of the buzzer 40 so that the duty ratio decreases as the predicted arrival time Tb decreases.

In addition, for example, in the first example, when determined that there is a probability of departure, the warning control unit 25 may control the operation of the buzzer 40 so that two different duty ratios that are determined in advance are alternately set. The probability of the driver noticing the warning can be increased by the level of warning being changed, compared to when the level of warning is constant. To enable the driver to easily recognize the degree of probability of departure by the changes in the level of warning, the increase and decrease in the level of warning and the increase and decrease in the probability of collision are preferably correlated.

### B-4. Fourth Variation Example

In the second example according to the above-described embodiment, the steering wheel 40 is used as the warning unit 40. However, this is not limited thereto. Other components through which a warning can be issued by vibration may be used. Other components include, for example, the driver's seat and a seatbelt provided on the driver's seat.

### B-5. Fifth Variation Example

In the fourth to sixth examples according to the above-described embodiment, the angles of entry θ, θₐ, and θ_{b} are acquired at a fixed cycle (FIG. 12, FIG. 14, and FIG. 17). However, this is not limited thereto. For example, as the angles of entry θ, Oₐ, and O_{b}, an angle that is initially acquired when the duty ratio of the buzzer 40 is determined using the respective relational expression may be used as a fixed value.

### B-6. Sixth Variation Example

According to the above-described embodiment, a detector may be used instead of the camera 12. The detector is capable of detecting the boundary line BA and the traffic lane TL. A radar sensor, such as a millimeter wave radar, or an image sensor may be used as the detector. In addition, the angles of entry θ, θₐ, and θ_{b} are generated based on information acquired from the camera 12. However, this is not limited thereto. For example, the angles of entry θ, θₐ, and θ_{b} may be determined by calculation using the lateral direction speed Vy of the vehicle 90 and the speed of the vehicle 90 in the direction along the traffic lane TL (vertical direction speed). Alternatively, the angles of entry may be determined by differentiating the lateral direction distance y. In addition, the lane recognizing unit 21 may recognize the traffic lane TL on which the vehicle 90 is traveling using information from the detector.

### B-7. Seventh Variation Example

According to the above-described embodiment, the warning reference position is set to the boundary line BA. However, this is not limited thereto. The warning reference position is merely required to be set to a position that serves as reference for the level of warning. The position that serves as reference for the level of warning is a position at which the level of warning is the highest. Alternatively, the position that serves as reference for the level of warning is a position at which the level of warning is the lowest. For example, the warning reference position may be set to a position between the control intervention position CS and the boundary line BA in the width direction. Alternatively, the warning reference position may be set to the control end position CF (FIG. 2) or the first control end position CF1 (FIG. 15).

The present disclosure is not limited to the above-described embodiment, examples, and variation examples. The present disclosure can be actualized by various configurations without departing from the scope of the disclosure. For example, the technical features in the embodiment, examples, and variation examples corresponding to the technical features of each aspect described in the summary can be exchanged or combined as appropriate to solve some or all of the above-described problems or to achieve some or all of the above-described effects. In addition, unless stated in the present specification as being an essential feature, the technical features can be omitted as appropriate.

What is claimed is:

1. A lane departure warning apparatus, mounted to a vehicle, for issuing a warning when there is a probability of departure of the vehicle from a traffic lane, the lane departure warning apparatus comprising:
a lane recognizing unit that recognizes the traffic lane on which the vehicle is traveling;
a departure determining unit that determines a probability of departure of the vehicle from the traffic lane based on a correlation between the vehicle and the traffic lane recognized by the lane recognizing unit;
a warning unit that issues a warning to a driver regarding the probability of departure; and
a warning control unit that changes a level of warning issued by the warning unit based on the probability of departure.

2. The lane departure warning apparatus according to claim 1, wherein:
the warning control unit sets the level of warning to be higher as the probability of departure increases.

3. The lane departure warning apparatus according to claim 2, wherein:
the warning control unit sets the level of warning to be the highest when the vehicle is positioned on a boundary line of the traffic lane on which the vehicle is traveling.

4. The lane departure warning apparatus according to claim 2, wherein:
the probability of departure is expressed by, when the vehicle travels on the traffic lane in a direction deviating from the traffic lane, a predicted arrival time required for the vehicle to arrive at a boundary line that serves as a warning reference position; and
the warning control unit sets the level of warning to be higher as the predicted arrival time becomes shorter.

5. The lane departure warning apparatus according to claim 3, wherein:
the probability of departure is expressed by, when the vehicle travels on the traffic lane in a direction deviating from the traffic lane, a predicted arrival time required for the vehicle to arrive at a boundary line that serves as a warning reference position; and
the warning control unit sets the level of warning to be higher as the predicted arrival time becomes shorter.

6. The lane departure warning apparatus according to claim 2, wherein:
the probability of departure is expressed by, when the vehicle travels on the traffic lane in a direction deviating from the traffic lane, an elapsed time that indicates an amount of time elapsed from when the departure determining unit determines that the vehicle travels in the direction deviating from the traffic lane and has arrived at a position within the traffic lane that is a predetermined distance away from a boundary line of the traffic lane; and
the warning control unit sets the level of warning to be higher as the elapsed time increases.

7. The lane departure warning apparatus according to claim 3, wherein:
the probability of departure is expressed by, when the vehicle travels on the traffic lane in a direction deviating from the traffic lane, an elapsed time that indicates an amount of time elapsed from when the departure determining unit determines that the vehicle travels in the direction deviating from the traffic lane and has arrived at a position within the traffic lane that is a predetermined distance away from a boundary line of the traffic lane; and
the warning control unit sets the level of warning to be higher as the elapsed time increases.

8. The lane departure warning apparatus according to claim 2, wherein:
the probability of departure is expressed by, when the vehicle travels on the traffic lane in a direction deviating from the traffic lane, a distance between the vehicle and a boundary line (BA) that serves as a warning reference position; and
the warning control unit sets the level of warning to be higher as the distance becomes shorter, and sets the level of warning for the same distance to be higher as a vehicle speed of the vehicle increases.

9. The lane departure warning apparatus according to claim 3, wherein:
the probability of departure is expressed by, when the vehicle travels on the traffic lane in a direction deviating from the traffic lane, a distance between the vehicle and a boundary line that serves as a warning reference position; and
the warning control unit sets the level of warning to be higher as the distance becomes shorter, and sets the level of warning for the same distance to be higher as a vehicle speed of the vehicle increases.

10. The lane departure warning apparatus according to claim 1, wherein:
the departure determining unit determines that the vehicle travels on the traffic lane in a direction deviating from the traffic lane and has arrived at a position within the traffic lane that is a predetermined distance away from a boundary line of the traffic lane, and subsequently determines, when the vehicle changes the direction to a direction returning inside the traffic lane, whether or not the vehicle has arrived at a control end position that is a predetermined distance away from the boundary line; and
the warning control unit controls the warning unit so as to issue the warning until the departure determining unit determines that the vehicles has arrived at the control end position.

11. The lane departure warning apparatus according to claim 1, wherein:
the departure determining unit determines that the vehicle travels on the traffic lane in a direction deviating from the traffic lane and has arrived at a position within the traffic lane that is a predetermined distance away from a boundary line of the traffic lane, and subsequently determines, when the vehicle changes the direction to a direction returning inside the traffic lane, whether or not the vehicle exceeds a control end position that is a predetermined distance away from the boundary line in an area on an outer side of the traffic lane, or whether or not the vehicle travels in the direction returning inside the traffic lane; and
the warning control unit controls the warning unit so as to end the warning when the departure determining unit determines that the vehicle exceeds the control end position or that the vehicle travels in the direction returning inside the traffic lane.

12. The lane departure warning apparatus according to claim 1, wherein:
the warning unit comprises at least one of a buzzer, a display panel and a steering wheel; and
the level of warning is expressed by at least one of a sounding state of the buzzer, a color of the display panel, and a vibration frequency of the steering wheel.

13. A lane departure warning method for issuing a warning when there is a probability of departure of a vehicle from a traffic lane, the lane departure warning method comprising:
recognizing, by a lane recognizing unit for a lane departure warning apparatus mounted to the vehicle, the traffic lane on which the vehicle is traveling;
determining, by a departure determining unit provided in the lane departure warning apparatus, a probability of departure of the vehicle from the traffic lane based on a correlation between the vehicle and the traffic lane recognized by the lane recognizing unit;
issuing, by a warning unit for the lane departure warning apparatus, a warning to a driver regarding the probability of departure; and
changing, by a warning control unit for the lane departure warning apparatus, a level of warning issued by the warning unit based on the probability of departure.
